(19) United States
(12) Patent Application Publication
(10) Pub. No.: US 2024/0405349 A1
(43) Pub. Date: Dec. 5, 2024

(54) PRESSURE RELIEF CAP FOR BATTERY MODULE

(71) Applicant: Caterpillar Inc., Peoria, IL (US)

(72) Inventors: Varun Malik, Peoria, IL (US); Dustin Irvin Landwehr, Kewanee, IL (US); Troy Watson, Athens, GA (US)

(73) Assignee: Caterpillar Inc., Peoria, IL (US)

(21) Appl. No.: 18/328,833

(22) Filed: Jun. 5, 2023

(51) Int. Cl. H01M 50/308; H01M 50/204; H01M 50/271

(52) U.S. Cl. CPC H01M 50/308; H01M 50/204; H01M 50/271

(57) ABSTRACT

A pressure relief cap for a battery module includes a body. The body includes a base portion defining a first thickness. The body also includes a first circular projection defining a second thickness that is lesser than the first thickness of the base portion. The first circular projection extends orthogonally from the base portion. The body further includes a second circular projection extending orthogonally from the base portion. The second circular projection is concentric with the first circular projection.

### TECHNICAL FIELD

The present disclosure relates to a battery module, and more particularly, to a pressure relief cap for the battery module and a method of venting the battery module.

### BACKGROUND

Battery modules are used in a variety of applications in order to provide and store energy. For example, battery modules are increasingly implemented in vehicles, machines, and the like. When implemented in mobile applications, battery modules are often stored such that the battery modules have minimum impact on cabin space, storage space, or other space needed for critical components associated with such mobile applications. In such instances, the battery modules include battery cells that are tightly packed together in close proximity, within a housing or other frame, of the battery module. The battery cells may also be environmentally sealed within the battery module to limit impacts of debris, fluids, and the like.

Given the sealing of the battery cells within the battery module, some battery modules include pressure relief components (e.g., valves, membranes, etc.) that vent pressures within the battery module under certain conditions. For example, in the event that one or more of the battery cells fail, the failing battery cells may release a relatively large volume of gas in a relatively short period of time, thereby causing a rapid increase in pressure within the sealed battery module. Such a failure may be referred to as a “runaway” event in which the temperature of the failing battery cells also increases rapidly. The sudden increase in battery module pressure during such a runaway event may cause undesirable impact to other battery module components if not released.

U.S. Pat. No. 10,833,304 describes a one-way valve, a top cover component, a box and a battery module. The one-way valve includes: a valve body including an inlet end, an exhaust end and an air-flow passage, the air-flow passage including a first flow-passing hole, a second flow-passing hole and a protrusion disposed on a bottom wall of the first flow-passing hole, the second flow-passing hole penetrating through the protrusion; an elastic valve cap, the protrusion being sheathed with and in a sealed connection with the elastic valve cap, a flow-passing gap is formed between an outer surface of the elastic valve cap and a hole wall of the first flow-passing hole, the second flow-passing hole includes a conical hole-section; a valve cover in connection with the exhaust end, wherein the valve cover is disposed within the first flow-passing hole and includes an exhaust passage in connection with the first flow-passing hole.

### SUMMARY OF THE DISCLOSURE

In an aspect of the present disclosure, a pressure relief cap for a battery module is provided. The pressure relief cap includes a body. The body includes a base portion defining a first thickness. The body also includes a first circular projection defining a second thickness that is lesser than the first thickness of the base portion. The first circular projection extends orthogonally from the base portion. The body further includes a second circular projection extending orthogonally from the base portion. The second circular projection is concentric with the first circular projection.

In another aspect of the present disclosure, a battery module is provided. The battery module includes a housing. The housing includes a first end plate defining a first end of the battery module. The housing also includes a second end plate defining a second end of the battery module opposite the first end. The housing further includes a first side plate coupled to the first end plate and the second end plate. The housing includes a second side plate opposite the first side plate. The second side plate is coupled to the first end plate and the second end plate. The battery module also includes a plurality of battery cells secured within the housing between the first end plate, the second end plate, the first side plate, and the second side plate. The battery module further includes a cover surrounding the plurality of battery cells. The cover forms a first substantially fluid-tight seal with the first end plate and a second substantially fluid-tight seal with the second end plate. The battery module includes a base plate coupled to the first end plate. The base plate has a through-opening and an inner surface facing the through-opening. The battery module also includes a pressure relief cap forming a third substantially fluid-tight seal with the first end plate. The pressure relief cap is coupled with the base plate. The pressure relief cap is adapted to disengage from the base plate upon an internal pressure within the battery module exceeding a pressure threshold. The pressure relief cap includes a body. The body includes a base portion defining a first thickness. The body also includes a first circular projection defining a second thickness that is lesser than the first thickness of the base portion. The first circular projection extends orthogonally from the base portion. The body further includes a second circular projection extending orthogonally from the base portion. The second circular projection is concentric with the first circular projection.

In yet another aspect of the present disclosure, a method of venting a battery module is provided. The method includes coupling, via at least one of an interference fit and a friction fit, a pressure relief cap with a base plate of the battery module. The pressure relief cap includes a body including a base portion, a first circular projection extending orthogonally from the base portion, and a second circular projection extending orthogonally from the base portion. The second circular projection is concentric with the first circular projection. The method also includes disengaging the pressure relief cap from the base plate upon an internal pressure within the battery module exceeding a pressure threshold. The method further includes venting the internal pressure within the battery module via a through-opening in the base plate based on the disengagement of the pressure relief cap from the base plate.

Other features and aspects of this disclosure will be apparent from the following description and the accompanying drawings.

### BRIEF DESCRIPTION OF THE DRAWINGS

FIG. 1 is a schematic perspective front view of a battery module, according to an example of the present disclosure;

FIG. 2 is a schematic perspective front view of the battery module of FIG. 1 with some components not shown;

FIG. 3 is a schematic perspective view illustrating a pressure relief cap of the battery module of FIG. 1 connected with a base plate of the battery module, according to an example of the present disclosure;

FIG. 4 is a schematic perspective view of the pressure relief cap of FIG. 3;

FIG. 5 is a schematic cross-sectional view of the pressure relief cap coupled with the base plate; and

FIG. 6 is a flowchart for a method of venting the battery module of FIG. 1, according to an example of the present disclosure.

### DETAILED DESCRIPTION

Wherever possible, the same reference numbers will be used throughout the drawings to refer to the same or like parts.

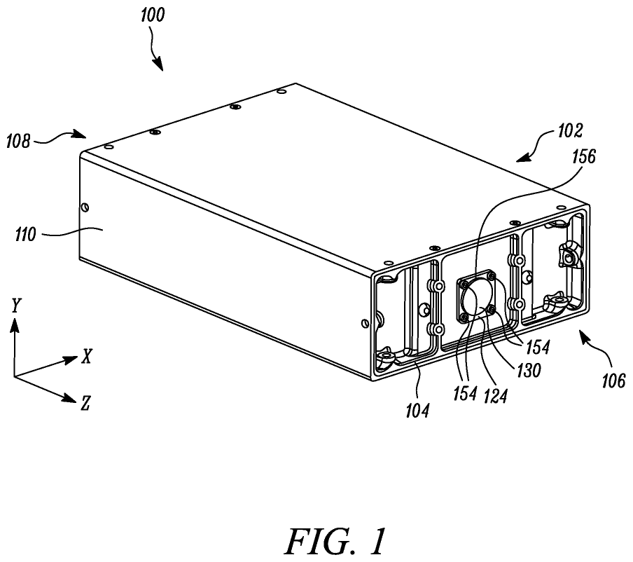

Referring to FIG. 1, a schematic perspective front view of an exemplary battery module 100 is illustrated. Generally, the battery module 100 supplies electrical power to a machine. The machine may include a moving machine or a stationary machine to which the battery module 100 may be electrically coupled. In some examples, the machine may be a truck, a work/construction machine, and the like.

The battery module 100 includes a housing 102. In some examples, the battery module 100, or components thereof, such as the housing 102, may be made of aluminum, composites, plastics, and/or any other suitable material. In some examples, multiple battery modules, which include similar housings may be electrically coupled to one another to provide a desired power output and voltage output. As such, although one battery module 100 is shown in FIG. 1, multiple battery modules may be electrically coupled together in a stacked relationship to provide a desired amount of power output.

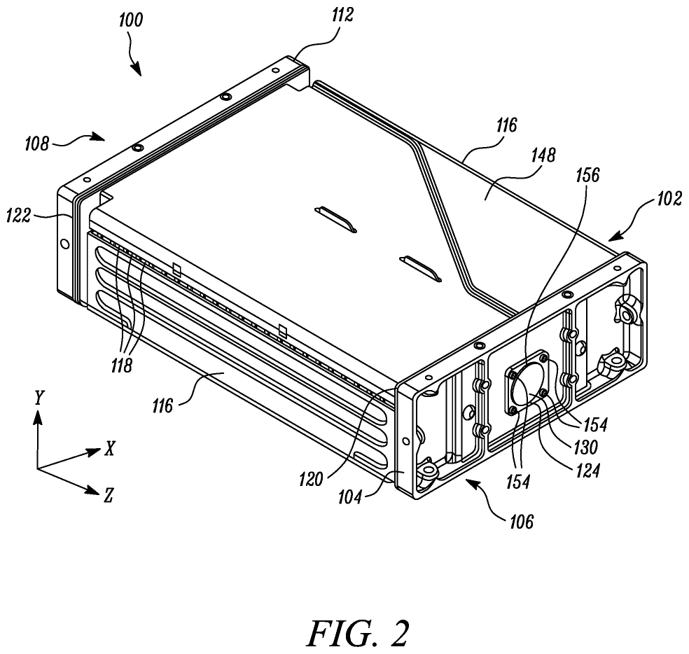

The housing 102 includes a first end plate 104 defining a first end 106 of the battery module 100. The first end plate 104 has a passage (not shown). The passage is sized to accommodate a base plate 124 therein. The housing 102 also includes a second end plate 112 (see FIG. 2) that defines a second end 108 of the battery module 100 opposite to the first end 106. The second end plate 112 is spaced apart from the first end plate 104 in a Z-direction.

Referring to FIG. 2, the housing 102 includes two side plates 116 extending along the Z-direction and parallel to each other. The housing 102 further includes a front plate (not shown in FIG. 2) and a rear plate (not shown in FIG. 2), each of which extends along the X-direction. The front plate is disposed adjacent to the first end plate 104 and the rear plate is disposed adjacent to the second end plate 112. The side plates 116 are connected to the front and rear plates, for example, by welding to form a box-shaped structure. Specifically, the housing 102 includes the first side plate 116 coupled to the first end plate 104 and the second end plate 112. The housing 102 further includes the second side plate 116 (obstructed from view in FIG. 2 but similar to the first side plate 116) opposite to the first side plate 116. It should be noted that, the two side plates 116 are spaced apart from one another (e.g., in a X-direction). Specifically, while the battery module 100 is depicted in whole, the front perspective view of the battery module 100 illustrates the first side plate 116 (nearest the viewer), and parts such as the second side plate 116 opposite to the first side plate 116 is disposed at the far end and obstructed from the view depicted in FIG. 2.

The second side plate 116 is coupled to the first end plate 104 and the second end plate 112. The first side plate 116 and the second side plate 116 extend from the first end plate 104 to the second end plate 112 (e.g., in the Z-direction) to define respective sides of the housing 102. The first side plate 116 couples to the first end plate 104 at the first end 106, and couples to the second end plate 112 at the second end 108. Further, the second side plate 116 couples to the first end plate 104 at the first end 106, and couples to the second end plate 112 at the second end 108.

The battery module 100 also includes one or more battery cells 118 secured within the housing 102 between the first end plate 104, the second end plate 112, the first side plate 116, and the second side plate 116. Further, the first side plate 116 and the second side plate 116 along with the first end plate 104 and the second end plate 112 of the housing 102 serve to house the battery cells 118 of the battery module 100. The first side plate 116 and the second side plate 116 along with the first end plate 104 and the second end plate 112 assist in retaining the battery cells 118 within the battery module 100 to prevent movement, shifting, and the like during use. Particularly, the first end plate 104, the second end plate 112, the first side plate 116, and the second side plate 116 are coupled to one another to define an exterior perimeter of the housing 102. Further, the battery cells 118 reside within the exterior perimeter.

The one or more battery cells 118 may have a lithium-ion battery technology to store electrical power and distribute the stored electrical power at a battery module voltage and a battery module amperage. It should be noted that the power distribution and power storage characteristics of the battery module 100 may be defined at least in part on the configurations of the one or more battery cells 118 included in the battery module 100. In other examples, the battery module 100 may embody any other type of battery technology such as a lead-acid battery technology, nickel metal hydride (NiMH) battery technology, and the like that converts chemical energy directly to electrical energy by utilizing a difference in bond energies of the compounds utilized in the construction of the battery module 100. Further, the battery cells 118 may include any capacity, voltage, energy, etc.

The battery module 100 may further include a top plate 148. In some cases, the top plate 148 covers at least a portion of the battery cells 118 that reside within the housing 102. Specifically, the top plate 148 is disposed vertically over or above (e.g., in a Y-direction) a top of the battery cells 118. In some examples, the top plate 148 may be made from a non-conductive material such as plastic, rubber, polymer, or any other suitable non-conductive material. In some other cases, the top plate 148 may define a flow path (not shown herein) that may assist in channeling gases released from the battery cells 118 towards the passage in the first end plate 104. In some other examples, the flow path may direct gases released from the battery cells 118 towards the passage in the first end plate 104 in case of a failure of the one or more battery cells 118.

Referring again to FIG. 1, the battery module 100 further includes a cover 110. The cover 110 surrounds one or more battery cells 118. The cover 110 couples to the first end plate 104. The first end plate 104 and the cover 110 couple to define an interior cavity, compartment, and the like of the battery module 100. It should be noted that the battery cells 118 are disposed within the interior cavity of the battery module 100. In some examples, the cover 110 is disposed around the battery cells 118, so as to enclose sides (e.g., lateral sides) of the battery module 100, while the first end plate 104 and the second end plate 112 couple to the cover 110 to enclose the respective first and second ends 106, 108 of the battery module 100.

The cover 110 is not illustrated in FIG. 2 to illustrate components disposed within the cover 110. With reference to FIGS. 1 and 2, the cover 110 forms a first substantially fluid-tight seal 120 with the first end plate 104 and a second substantially fluid-tight seal 122 with the second end plate 112.

The battery module 100 further includes the base plate 124. The base plate 124 is coupled to the first end plate 104. The battery module 100 also includes a pressure relief cap 130. The pressure relief cap 130 forms a third substantially fluid-tight seal 156 with the first end plate 104. In other words, the pressure relief cap 130 may be impermeable to gases and/or other fluids so as to enclose or seal the battery module 100 and therefore, forms the third substantially fluid-tight seal 156. The pressure relief cap 130 is coupled with the base plate 124 of the battery module 100.

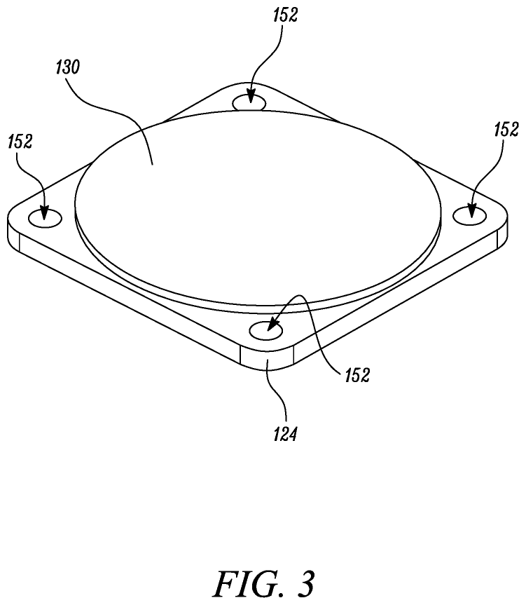

FIG. 3 is a schematic perspective view illustrating the pressure relief cap 130 coupled with the base plate 124. In the illustrated example of FIG. 3, the base plate 124 has a square shape. In other examples, the base plate 124 may have a rectangular shape, a circular shape, or any other shape, based on application attributes. The shape of the base plate 124 may be similar to a shape of the passage in the first end plate 104 (see FIG. 1).

The base plate 124 may have one or more holes 152. Each hole 152 receives a corresponding fastening means 154 (see FIG. 2) that allows the base plate 124 to couple to the first end plate 104. In some examples, the fastening means 154 may be a bolt, a screw, a rivet, and the like. In some examples, the base plate 124 may be made of nylon. In other examples, the base plate 124 may be made of any composite, plastic, rubber, and/or combinations thereof. Further, in the illustrated example of FIG. 3, the pressure relief cap 130 has a circular shape.

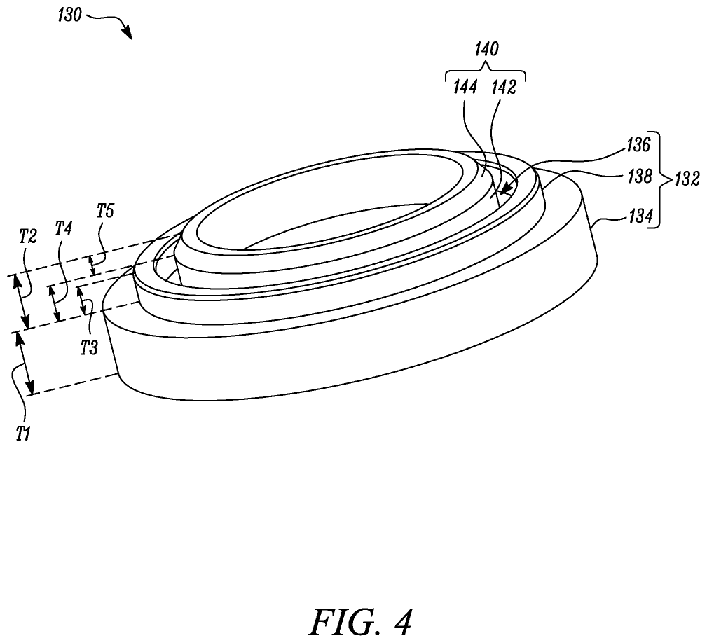

FIG. 4 is a schematic perspective view of the pressure relief cap 130, according to an example of the present disclosure. The pressure relief cap 130 may be used on sealed battery modules that may or may not include an atmospheric vent. The pressure relief cap 130 includes a body 132. The body 132 may be made of a thermoplastic material. In some examples, the body 132 may be made of low-density polyethylene (LDPE). Alternatively, the body 132 may be made from any composite, plastic, rubber, and/or combinations thereof.

The body 132 includes a base portion 134. The base portion 134 defines a first thickness T1. The body 132 also includes a first circular projection 136. The first circular projection 136 defines a second thickness T2 that is lesser than the first thickness T1 of the base portion 134. The first circular projection 136 extends orthogonally from the base portion 134. The first circular projection 136 includes an outer surface 140 having a first surface portion 142 and a second surface portion 144 connected to the first surface portion 142. Further, the first surface portion 142 extends from the base portion 134 up to the second surface portion 144. Furthermore, the first surface portion 142 includes a straight profile and the second surface portion 144 includes a tapering profile. In some examples, a thickness T4 of the first surface portion 142 may be same as a thickness T5 of the second surface portion 144. Alternatively, the thickness T4 of the first surface portion 142 may be different from the thickness T5 of the second surface portion 144. It should be noted that the thickness T4, T5 of the first and second surface portions 142, 144 may vary as per application requirements.

The body 132 further includes a second circular projection 138. The second circular projection 138 extends orthogonally from the base portion 134. The second circular projection 138 is concentric with the first circular projection 136. Specifically, the first and second circular projections 136, 138 are radially spaced apart from each other. The second circular projection 138 defines a third thickness T3 that is lesser than the second thickness T2 of the first circular projection 136. In other words, the third thickness T3 is lesser than each of the first thickness T1 and the second thickness T2. It should be noted that the pressure relief cap 130 may represent a structure formed from a single piece of material. In other words, the base portion 134, the first circular projection 136, and the second circular projection 138 may altogether represent the one-piece body 132 of the pressure relief cap 130. In an example, the pressure relief cap 130 may be injection molded. Alternatively, the pressure relief cap 130 may be made from any other manufacturing technique known in the art.

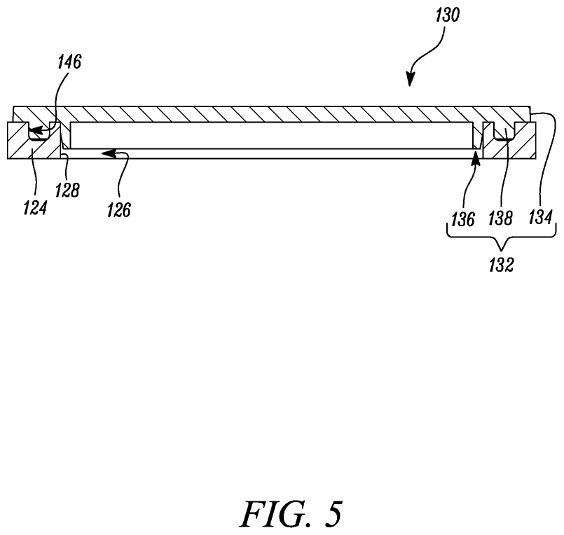

FIG. 5 is a schematic cross-sectional view of the pressure relief cap 130 coupled with the base plate 124 of the battery module 100 of FIG. 1. The base plate 124 has a through-opening 126 and an inner surface 128 facing the through-opening 126. The first circular projection 136 couples with the base plate 124 via a friction fit. When the body 132 is coupled with the base plate 124, the through-opening 126 of the base plate 124 receives the first circular projection 136 of the body 132 therein. Further, when the body 132 is coupled with the base plate 124, the inner surface 128 of the base plate 124 engages with the first surface portion 142 of the first circular projection 136. Thus, the first surface portion 142 engages with the inner surface 128 of the body 132 by the friction fit.

Furthermore, the base plate 124 has a circular groove 146. The circular groove 146 is concentric with the through-opening 126 of the base plate 124. When the body 132 is coupled with the base plate 124, the circular groove 146 receives the second circular projection 138 of the body 132 therein. The second circular projection 138 couples with the base plate 124 via an interference fit.

Further, the pressure relief cap 130 disengages from the base plate 124 upon an internal pressure within the battery module 100 exceeding a pressure threshold. In other words, the pressure relief cap 130 decouples from the base plate 124. Thus, when the internal pressure exceeds the pressure threshold, the first surface portion 142 of the first circular projection 136 disengages from the inner surface 128 of the base plate 124 and the second circular projection 138 disengages from the circular groove 146.

In some examples, the pressure relief cap 130 may disengage when the internal pressure within the battery module 100 exceeds 12 pound-force per square inch (PSI). In other examples, a value of the pressure threshold may be in a range of 10 PSI to 14 PSI. However, in some examples, the pressure relief cap 130 may disengage from the base plate 124 when the internal pressure within the battery module 100 exceeds 14 PSI, without any limitations. It should be noted that the value of the pressure threshold may vary as per application requirements. It should be further noted that the pressure relief cap 130 may disengage at certain internal pressures based on a size of the pressure relief cap 130, the thicknesses T1, T2, T3 (see FIG. 4) of the body 132, the first circular projection 136, and the second circular projection 138, a material of the pressure relief cap 130 (e.g., tensile strength), and so forth.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The pressure relief cap 130 of the present disclosure may prevent damage to one or more components of the battery module 100 and/or other undesirable effects in the case of a runaway event or a failure of the battery cells 118. For example, the pressure relief cap 130 may vent the internal pressure within the battery module 100 in case of a failure of one or more battery cells 118. During such failure, gases from one or more of the battery cells 118 vent into the interior cavity of the battery module 100. Chemical reactions within the battery module 100 generate extreme amounts of heat (thermal runaway) and give off gas. As a result of the rapidly rising internal pressure i.e., when the internal pressure exceeds the pressure threshold, the pressure relief cap 130 disengages from the base plate 124 and enables the battery module 100 to depressurize. Specifically, the pressure relief cap 130 disengages in the outward direction (e.g., in the Z-direction), away from the housing 102, to expel gases and/or fluids from within the housing 102. Such a depressurization may prevent rupture or failure of the battery module 100 itself and may also prevent damage to components located around the battery module 100.

The gases released by the battery cells 118 during failure are routed, directed, or otherwise channeled via the flow path on the top plate 148 of the battery module 100. Further, regardless of which battery cell 118 within the battery module 100 fails, or the number of battery cells 118 that fail, the gases are routed to the location at which the pressure relief cap 130 is disposed such that the pressure relief cap 130 releases the internal pressure within the battery module 100. Hence, releasing the internal pressure from the battery module 100 via the pressure relief cap 130 may safely discharge the internal pressure at a designated location thereby avoiding damage to any components surrounding the battery module 100 and/or other harmful effects.

The pressure relief cap 130 described herein is simple in construction and cost-effective. Further, the pressure relief cap 130 may be coupled to the base plate 124 in a time efficient manner without requiring costly set-ups or high operator expertise.

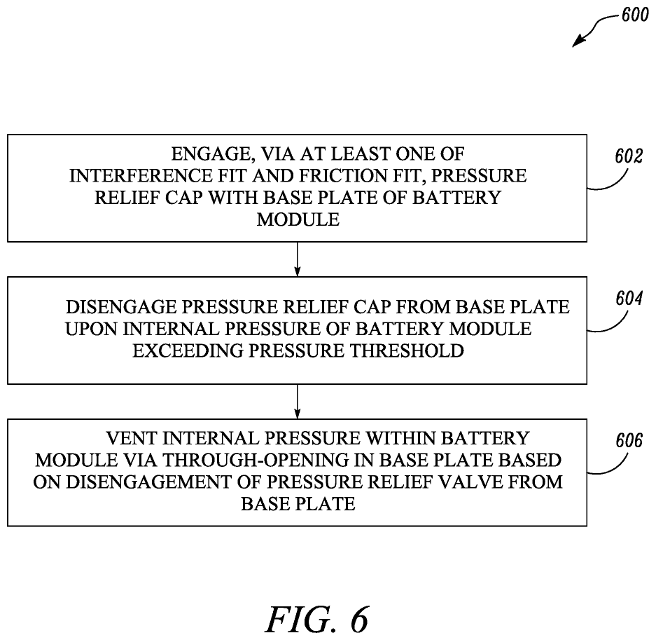

FIG. 6 is a flowchart for a method 600 of venting the battery module 100 of FIG. 1. With reference to FIGS. 1 to 6, at step 602, the pressure relief cap 130 is coupled with the base plate 124 of the battery module 100 via the interference fit and/or the friction fit. The pressure relief cap 130 includes the body 132 including the base portion 134, the first circular projection 136 extending orthogonally from the base portion 134, and the second circular projection 138 extending orthogonally from the base portion 134. The second circular projection 138 is concentric with the first circular projection 136.

The first circular projection 136 includes the outer surface 140 having the first surface portion 142 and the second surface portion 144 connected to the first surface portion 142. The base plate 124 includes the inner surface 128 facing the through-opening 126. Further, the first circular projection 136 of the body 132 is received within the through-opening 126 of the base plate 124 such that the inner surface 128 of the base plate 124 engages with the first surface portion 142 of the first circular projection 136.

Furthermore, the first circular projection 136 of the body 132 is coupled with the base plate 124 via the friction fit and the second circular projection 138 of the body 132 is coupled with the base plate 124 via the interference fit.

The base plate 124 has the circular groove 146. Further, the second circular projection 138 of the body 132 is received within the circular groove 146 of the base plate 124.

### Caterp

At step 604, the pressure relief cap 130 disengages from the base plate 124 upon the internal pressure exceeding the pressure threshold within the battery module 100.

At step 606, the internal pressure within the battery module 100 is vented via the through-opening 126 in the base plate 124 based on the disengagement of the pressure relief cap 130 from the base plate 124.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A pressure relief cap for a battery module, the pressure relief cap comprising:
a body including:
a base portion defining a first thickness;
a first circular projection defining a second thickness that is lesser than the first thickness of the base portion, wherein the first circular projection extends orthogonally from the base portion; and
a second circular projection extending orthogonally from the base portion, wherein the second circular projection is concentric with the first circular projection.

2. The pressure relief cap of claim 1, wherein the second circular projection defines a third thickness that is lesser than the second thickness of the first circular projection.

3. The pressure relief cap of claim 1, wherein the first circular projection includes an outer surface having a first surface portion and a second surface portion connected to the first surface portion, wherein the first surface portion extends from the base portion up to the second surface portion, and wherein the first surface portion includes a straight profile and the second surface portion includes a tapering profile.

4. The pressure relief cap of claim 3, wherein the body of the pressure relief cap is adapted to be coupled with a base plate of the battery module, wherein the base plate includes a through-opening and an inner surface facing the through-opening, wherein, when the body is coupled with the base plate, the through-opening of the base plate is adapted to receive the first circular projection of the body therein, and wherein, when the body is coupled with the base plate, the inner surface of the base plate is adapted to engage with the first surface portion of the first circular projection.

5. The pressure relief cap of claim 4, wherein the first circular projection is adapted to be coupled with the base plate via a friction fit.

6. The pressure relief cap of claim 4, wherein the second circular projection is adapted to be coupled with the base plate via an interference fit.

7. The pressure relief cap of claim 4, wherein the base plate has a circular groove, and wherein, when the body is coupled with the base plate, the circular groove is adapted to receive the second circular projection of the body therein.

8. The pressure relief cap of claim 1, wherein the body is made of a thermoplastic material.

9. A battery module, comprising:
a housing including:
a first end plate defining a first end of the battery module;
a second end plate defining a second end of the battery module opposite the first end;
a first side plate coupled to the first end plate and the second end plate; and
a second side plate opposite to the first side plate, the second side plate being coupled to the first end plate and the second end plate;
a plurality of battery cells secured within the housing between the first end plate, the second end plate, the first side plate, and the second side plate;
a cover surrounding the plurality of battery cells, the cover forming a first substantially fluid-tight seal with the first end plate and a second substantially fluid-tight seal with the second end plate;
a base plate coupled to the first end plate, the base plate having a through-opening and an inner surface facing the through-opening; and
a pressure relief cap forming a third substantially fluid-tight seal with the first end plate, wherein the pressure relief cap is coupled with the base plate, and wherein the pressure relief cap is adapted to disengage from the base plate upon an internal pressure within the battery module exceeding a pressure threshold, the pressure relief cap including:
a body including:
a base portion defining a first thickness;
a first circular projection defining a second thickness that is lesser than the first thickness of the base portion, wherein the first circular projection extends orthogonally from the base portion; and
a second circular projection extending orthogonally from the base portion, wherein the second circular projection is concentric with the first circular projection.

10. The battery module of claim 9, wherein the second circular projection of the body defines a third thickness that is lesser than the second thickness of the first circular projection.

11. The battery module of claim 9, wherein the first circular projection includes an outer surface having a first surface portion and a second surface portion connected to the first surface portion, wherein the first surface portion extends from the base portion up to the second surface portion, and wherein the first surface portion includes a straight profile and the second surface portion includes a tapering profile.

12. The battery module of claim 11, wherein the through-opening of the base plate receives the first circular projection of the body therein, and wherein the inner surface of the base plate engages with the first surface portion of the first circular projection.

13. The battery module of claim 9, wherein the first circular projection is coupled with the base plate via a friction fit.

14. The battery module of claim 9, wherein the second circular projection is coupled with the base plate via an interference fit.

15. The battery module of claim 9, wherein the base plate has a circular groove that receives the second circular projection of the body therein.

16. The battery module of claim 9, wherein the body is made of a thermoplastic material.

17. A method of venting a battery module, the method comprising:
coupling, via at least one of an interference fit and a friction fit, a pressure relief cap with a base plate of the battery module, the pressure relief cap including a body including a base portion, a first circular projection extending orthogonally from the base portion, and a second circular projection extending orthogonally from the base portion, wherein the second circular projection is concentric with the first circular projection;
disengaging the pressure relief cap from the base plate upon an internal pressure within the battery module exceeding a pressure threshold; and
venting the internal pressure within the battery module via a through-opening in the base plate based on the disengagement of the pressure relief cap from the base plate.

18. The method of claim 17, wherein the first circular projection includes an outer surface having a first surface portion and a second surface portion connected to the first surface portion, wherein the base plate includes an inner surface facing the through-opening, and wherein the step of coupling the pressure relief cap with the base plate further includes receiving the first circular projection of the body within the through-opening of the base plate such that the inner surface of the base plate engages with the first surface portion of the first circular projection.

19. The method of claim 17, wherein the step of coupling the pressure relief cap with the base plate further includes:
coupling the first circular projection of the body with the base plate via the friction fit; and
coupling the second circular projection of the body with the base plate via the interference fit.

20. The method of claim 17, wherein the base plate has a circular groove, and wherein the step of coupling the pressure relief cap with the base plate further includes receiving the second circular projection of the body within the circular groove of the base plate.
